(19) United States
(12) Patent Application Publication
(10) Pub. No.: US 2021/0191690 A1
(43) Pub. Date: Jun. 24, 2021

(54) Virtual Reality Device Control Method And Apparatus, And Virtual Reality Device And System

(71) Applicant: JINGWAH INFORMATION TECHNOLOGY CO., LTD., Shenzhen City , Guangdong (CN)

(72) Inventors: Jiancai Zou, Shenzhen City, Guangdong (CN); Jianhua Jiang, Shenzhen City, Guangdong (CN); Deming Jiang, Shenzhen City, Guangdong (CN)

(73) Assignee: JINGWAH INFORMATION TECHNOLOGY CO., LTD., Shenzhen City, Guangdong, OT (CN)

(21) Appl. No.: 16/075,901

(22) PCT Filed: Feb. 22, 2017
(86) PCT No.: PCT/CN2017/074334

§ 371 Date: Aug. 6, 2018

(30) Foreign Application Priority Data
Apr. 12, 2016 (CN) 201610223153.1

(51) Int. Cl. G06F 3/16; G10L 15/34; G06T 19/00; H04L 29/06

(52) U.S. Cl. CPC G06F 3/167; G10L 15/34; H04L 67/38; H04L 67/42; G06T 19/003

(57) ABSTRACT

Disclosed are a virtual reality device control method and apparatus, and a virtual reality device and system. The method comprises: acquiring a voice signal; performing local speech recognition on the voice signal; if a local speech recognition library cannot recognize the voice signal, sending the voice signal to a cloud management server to perform speech recognition; and receiving an operation instruction, sent by the cloud management server, obtained after the voice signal is recognized, executing the operation instruction, and acquiring a resource matching the operation instruction from the Internet.

### TECHNICAL FIELD

Embodiments of the present disclosure relate to the field of Internet application technologies, for example, to a method and an apparatus for controlling a virtual reality device, a virtual reality device and a system

### BACKGROUND

A virtual reality technology is a computer simulation system that can create a virtual world for used in experience. The technology uses a computer to generate a simulation environment, and hence is considered as a system simulation for a multi-source information fusion interactive 3D dynamic vision and entity behavior, thereby immersing users into this environment. The virtual reality devices in the related art are usually operated manually, which is very inconvenient, and also the available resources are very limited.

### SUMMARY

Embodiments of the present disclosure provide a method and an apparatus for controlling a virtual reality device, a virtual reality device and a system, which can solve the technical problem in the related art that the virtual reality device is inconvenient to operate manually and available resources are very limited, thus simplifying the operation, providing the convenient use and greatly expanding the available resources.

The embodiments of the present disclosure employ the following technical solutions.

In a first aspect, an embodiment of the present disclosure provides a method for controlling a virtual reality device. The method includes:

acquiring a voice signal;

performing local speech recognition on the voice signal;

sending the voice signal to a cloud management server for performing speech recognition, if the voice signal is not recognized by a local speech recognition library; and

receiving an operation instruction sent by the cloud management server which is obtained upon the recognition of the voice signal, executing the operation instruction and acquiring from the Internet the resource matching the operation instruction.

Optionally, the speech signal recognizable by the local speech recognition library includes at least one of: opening a video, playing a next video, playing a previous video, fast forward, fast backward, increasing a volume, decreasing a volume, pausing, continuing to play, and shutdown.

Optionally, after receiving the operation instruction sent by the cloud management server which is obtained upon the recognition of the voice signal, executing the operation instruction and acquiring from the Internet the resource matching the operation instruction, the method further includes:

presenting the resource in a manner of speech, image, vibration, smell, and/or graphic-text displaying.

Optionally, the receiving the operation instruction sent by the cloud management server which is obtained upon the recognition of the voice signal, executing the operation instruction and acquiring from the Internet the resource matching the operation instruction may include:

receiving the operation instruction sent by the cloud management server which is obtained upon the recognition of the voice signal, with the operation instruction being a clothing brand, and acquiring a virtual store of the clothing brand from the Internet.

Optionally, a speech recognition capability of the cloud management server is adaptively learned via speech recognition resources in a cloud.

In a second aspect, an embodiment of the present application provides an apparatus for controlling a virtual reality device. The apparatus includes:

a voice signal acquiring unit, configured to acquire a voice signal;

a local speech recognizing unit, configured to perform local speech recognition on the voice signal;

a voice signal sending unit, configured to send the voice signal to a cloud management server for performing speech recognition, if the voice signal is not recognized by a local speech recognition library; and

an operation instruction executing unit, configured to receive an operation instruction sent by the cloud management server which is obtained upon recognition of the voice signal, execute the operation instruction, and acquire from the Internet the resource matching the operation instruction.

Optionally, the speech signal recognizable by the local speech recognition library comprises at least one of: opening a video, playing a next video, playing a previous video, fast forward, fast backward, increasing a volume, decreasing a volume, pausing, continuing to play, and shutdown.

Optionally, the apparatus further includes:

a result presenting unit, configured to present the resource in a manner of speech, image, vibration, smell or graphic-text displaying.

In a third aspect, an embodiment of the present disclosure provides a virtual reality device. The virtual reality device includes: a controller, a wireless network circuit, a speech recognition circuit and a microphone. The controller is provided with the above apparatus for controlling the virtual reality device, the wireless network circuit and the speech recognition circuit are connected to the controller, the microphone is connected to the speech recognition circuit, the wireless network circuit is configured to connect to the Internet, the speech recognition circuit is configured to convert a voice signal into an operation instruction, and the microphone is configured to collect the voice signal.

In a fourth aspect, an embodiment of the present disclosure provides a virtual reality system. The virtual reality system includes the above virtual reality device and the cloud management server.

In a fifth aspect, an embodiment of the present disclosure provides a non-transitory computer readable storage medium for storing computer executable instructions which executes the above method for controlling the virtual reality device.

In the technical solution according to the present disclosure, the voice signal is recognized by the local voice recognition library firstly. When the local voice recognition library cannot recognize the voice signal, the voice signal will be sent to the cloud management server for performing the recognition. Then, the recognized operation instruction is sent to the virtual reality device. The virtual reality device executes the operation instruction, and acquires the resource matching the operation instruction from the Internet. The local speech recognition library only stores simple and direct operation instructions, thereby saving the storage of the virtual reality device. Also, the voice recognition is performed in conjunction with the cloud management server, thereby enhancing the capacities of the voice recognition, solving the technical problem of inconvenient operation of the virtual reality device, and improving the user experience.

### BRIEF DESCRIPTION OF THE DRAWINGS

The drawings to be used in the description for the embodiments of the present disclosure will be briefly described below, and the drawings descried below are merely some embodiments of the present disclosure.

FIG. 1 is a flowchart of a first embodiment of a method for controlling a virtual reality device according to the present disclosure.

FIG. 2 is a flowchart of a second embodiment of a method for controlling a virtual reality device according to the present disclosure.

FIG. 3 is a structural block diagram showing a first embodiment of an apparatus for controlling a virtual reality device according to the present disclosure.

FIG. 4 is a structural block diagram showing a second embodiment of an apparatus for controlling a virtual reality device according to the present disclosure.

FIG. 5 is a structural block diagram of a virtual reality device according to the present disclosure.

FIG. 6 is a structural block diagram of a virtual reality system according to the present disclosure.

FIG. 7 is a structural block diagram of an electronic device according to an embodiment of the present disclosure.

### DETAILED DISCLOSURE

The technical solutions of the embodiments of the present disclosure will be described in detail below with reference to the accompanying drawings. The described embodiments are only a part of but not all the embodiments of the present disclosure. The following embodiments and the features thereof may be combined with each other without conflict. The virtual reality device provided in the present disclosure is a master control device in a plurality of application systems, which mainly includes an immersive virtual reality system, a computer-based virtual reality system, and an integrated head-mounted virtual reality system. Specifically, the immersive virtual reality system is a relatively complex system in which a user is in a special device and must wear some sensor tracking device, such as a helmet or a data glove, so as to interact with the virtual world. The computer-based virtual reality system is such a system in which a personal computer is used as a host computer for data processing and program running, and the user wears a virtual reality helmet in order to interact with the virtual environment through a handle, etc. The integrated head-mounted virtual reality system may have three forms, which are respectively virtual reality glasses matching with a host computer, an integrated virtual reality head-mounted device, and a virtual reality shell matching with a smartphone.

With the development of simulation technologies, perceptive technologies and sensing technologies, application fields of the virtual reality device are gradually enriched, mainly including virtual training bases, educational applications, engineering applications, commercial applications, game entertainments, films and televisions, and live broadcasts, and thus have great commercial values.

FIG. 1 is a flowchart of a first embodiment of a method for controlling a virtual reality device according to the present disclosure. Referring to FIG. 1, the method for controlling a virtual reality device includes the following steps.

In Step S110, a voice signal is acquired.

Optionally, a voice signal from a user is acquired via a microphone, and the voice signal is converted into an electrical signal.

In Step S120, local speech recognition is performed on the voice signal.

In this embodiment, the speech recognition method is mainly a pattern matching method. Instructions or key words of the instructions, such as “play”, “shutdown”, were preset in the device software, and there is no need for the user on operation.

In Step S130, if the voice signal cannot be recognized by a local speech recognition library, then the voice signal is sent to a cloud management server for performing speech recognition.

The speech signal recognizable by the local speech recognition library may include: opening a video, playing a next video, playing a previous video, fast forward, fast backward, increasing a volume, decreasing a volume, pausing, continuing to play, and shutdown, etc. The feature vector of each of the vocabularies is stored in the local speech recognition library. The vocabularies listed here are only examples. The used vocabularies may be different according to the different application scenarios of the virtual reality device. In short, the local speech recognition library only includes simple vocabularies related to operation of the device. If the local speech recognition library can recognize the voice signal, an operation instruction corresponding to the voice signal is directly executed.

The cloud management server is configured to assist in performing speech recognition processing and is also the server for user network operation management. The cloud management server acquires voice recognition resources from the Internet and has adaptive learning capabilities, so that it can recognize a various of voice signals, thereby enriching the services provided by the virtual reality device and providing more abundant resources for the users.

After receiving the voice signal sent by the virtual reality device, the cloud management server uses the voice recognition resources of the Internet to perform voice recognition on the voice signal, and obtains an operation instruction corresponding to the voice signal. The voice recognition capability of the cloud management server is adaptively learned via the voice recognition resources in the cloud.

In Step S140, an operation instruction sent by the cloud management server which is obtained after the voice signal is recognized is received, the operation instruction is executed and a resource matching the operation instruction is acquired from the Internet.

With the development of virtual reality technologies, more and more virtual reality resources are shared on the Internet and involve multiple fields. The virtual reality device has a network access function, and acquires from the Internet the resource matching the operation instruction after receiving the operation instruction sent by the cloud management server.

Optionally, after the virtual reality device acquires the resource matching the operation instruction from the Internet, the resource is presented to the user in a manner of voice, image, vibration, smell, or graphic-text displaying. The presentation mode is determined by an application scenario of the virtual reality device, which is not limited herein. For example, 720 degrees of film viewing without dead ends, along with touch and smell would provide the user with an immersive feeling; also, when the user plays a shooting game, the player is completely immersed in the game and becomes one of roles; in this way, he can feel being shot, car shaking, wind blowing and raining, etc.

In summary, in the method for controlling the virtual reality device according to the present disclosure, the voice signal of the user is recognized by the local voice recognition library. When the local voice recognition library cannot recognize the voice signal, the voice signal will be sent to the cloud management server for performing the recognition. Then, the recognized operation instruction is sent to the virtual reality device. The virtual reality device executes the operation instruction, and acquires the resource matching the operation instruction from the Internet. The local speech recognition library only stores simple and direct operation instructions, thereby saving the storage of the virtual reality device. Also, the voice recognition is performed in conjunction with the cloud management server, thereby enhancing the capacities of the voice recognition, solving the technical problem of inconvenient operation of the virtual reality device, and improving the user experience.

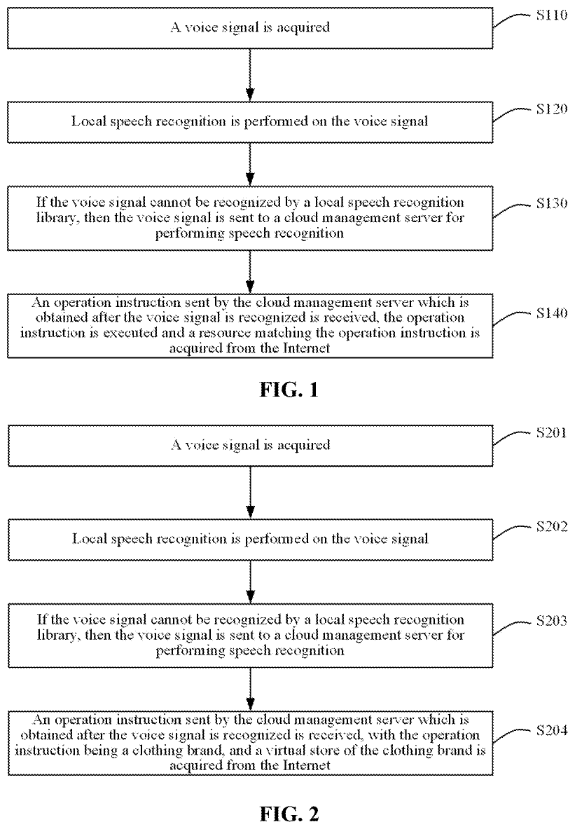

FIG. 2 is a flowchart of a second embodiment of a method for controlling a virtual reality device according to the present disclosure. Referring to FIG. 2, the method for controlling a virtual reality device includes the following Steps.

In Step S201, a voice signal is acquired.

Optionally, a voice signal from a user is acquired via a microphone, and the voice signal is converted into an electrical signal.

In Step S202, local speech recognition is performed on the voice signal.

In this embodiment, the speech recognition method is mainly a pattern matching method. Instructions or key words of the instructions, such as “play”, “shutdown”, were preset in the device software, and there is no need for the user on operation.

In Step S203, if the voice signal cannot be recognized by a local speech recognition library, then the voice signal is sent to a cloud management server for performing speech recognition.

The speech signal recognizable by the local speech recognition library may include: opening a video, playing a next video, playing a previous video, fast forward, fast backward, increasing a volume, decreasing a volume, pausing, continuing to play, and shutdown, etc. The feature vector of each of the vocabularies is stored in the local speech recognition library. The vocabularies listed here are only examples. The used vocabularies may be different according to the different application scenarios of the virtual reality device. In short, the local speech recognition library only includes simple vocabularies related to operation of the device.

The cloud management server is configured to assist in performing speech recognition processing and is also the server for user network operation management. The cloud management server acquires voice recognition resources from the Internet and has adaptive learning capabilities, so that it can recognize a various of voice signals, thereby enriching the services provided by the virtual reality device and providing more abundant resources for the users

After receiving the voice signal sent by the virtual reality device, the cloud management server uses the voice recognition resources of the Internet to perform voice recognition on the voice signal, and obtains an operation instruction corresponding to the voice signal.

In Step S204, an operation instruction sent by the cloud management server which is obtained after the voice signal is recognized is received, with the operation instruction being a clothing brand, and a virtual store of the clothing brand is acquired from the Internet.

With the increasing popularity of e-commerce, the Internet is particularly attractive to many large companies and businesses. Establishing a virtual three-dimensional shopping scene can greatly improve the customer's experience of purchasing goods. The customers can make “shopping” on the stores in the virtual world, pick up the goods, and process the payment through the Internet. The store will deliver the goods to the customers in time. For the business promotions and sales on real estates and large-scale valuable products which are not convenient to move, the customers can view the appearance and internality of the products before buying, even can use the products in the virtual world. Thus, it is very helpful to sales of houses, lands, boilers, large-scale machines, furniture, medical equipment and fitness equipment.

Optionally, the virtual store is presented to the user, and the user can select the clothes in the virtual store, which is convenient and quick.

In summary, the method for controlling the virtual reality device according to the present disclosure can be applied in the commercial field. The voice signal of the user is recognized by the local voice recognition library. When the local voice recognition library cannot recognize the voice signal, the voice signal is sent to the cloud management server for recognition. The recognized operation instruction is a clothing brand, and then the virtual reality device acquires the virtual store of the clothing brand from the Internet. The local speech recognition library only stores simple and direct operation instructions, thereby saving the storage of the virtual reality device. Also, the voice recognition is performed in conjunction with the cloud management server, thereby enhancing the capacities of the voice recognition, fully utilizing the network resources, solving the technical problem of inconvenient operation of the virtual reality device, and improving the user experience.

FIG. 3 is a structural block diagram showing a first embodiment of an apparatus for controlling a virtual reality device according to the present disclosure. Referring to FIG. 3, the apparatus for controlling a virtual reality device includes: a voice signal acquiring unit 100, a local speech recognizing unit 101, a voice signal sending unit 102 and an operation instruction executing unit 103.

The voice signal acquiring unit 101 is configured to acquire a voice signal from a user.

The local speech recognizing unit 102 is configured to perform local speech recognition on the voice signal.

The voice signal sending unit 103 is configured to send the voice signal to a cloud management server for performing speech recognition, if the voice signal cannot be recognized by a local speech recognition library. The speech signal recognizable by the local speech recognition library may include: opening a video, playing a next video, playing a previous video, fast forward, fast backward, increasing a volume, decreasing a volume, pausing, continuing to play, and shutdown, etc.

The operation instruction executing unit 103 is configured to receive an operation instruction sent by the cloud management server which is obtained upon recognition of the voice signal, execute the operation instruction, and acquire from the Internet the resource matching the operation instruction. Further, the operation instruction executing unit 103 is configured to receive the operation instruction sent by the cloud management server which is obtained upon the recognition of the voice signal, with the operation instruction being a clothing brand, and acquire a virtual store of the clothing brand from the Internet.

The detail of the apparatus can refer to that of the method shown in FIG. 1 and hence is not discussed again here.

In summary, in the apparatus for controlling the virtual reality device according to the present disclosure, the voice signal of the user is recognized by the local voice recognition library. When the local voice recognition library cannot recognize the voice signal, the voice signal will be sent to the cloud management server for performing the recognition. Then, the recognized operation instruction is sent to the virtual reality device. The virtual reality device executes the operation instruction, and acquires the resource matching the operation instruction from the Internet. The local speech recognition library only stores simple and direct operation instructions, thereby saving the storage of the virtual reality device. Also, the voice recognition is performed in conjunction with the cloud management server, thereby enhancing the capacities of the voice recognition, solving the technical problem of inconvenient operation of the virtual reality device, and improving the user experience.

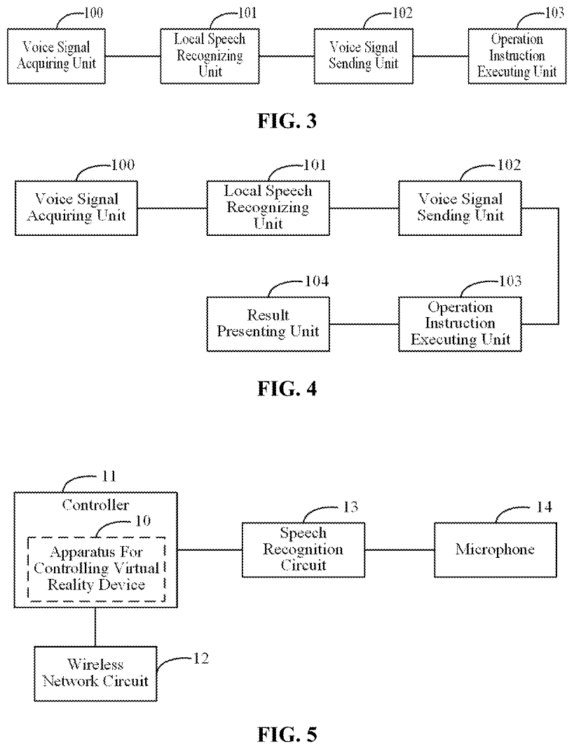

FIG. 4 is a structural block diagram showing a second embodiment of an apparatus for controlling a virtual reality device according to the present disclosure. Referring to FIG. 4, the apparatus for controlling the virtual reality device is different from the apparatus shown in FIG. 3 in that it further includes: a result presenting unit 104, which is configured to present the resource in at least one manner of speech, image, vibration, smell and graphic-text displaying, etc.

The resources obtained from the Internet are presented to the user, providing the user with an immersive feeling and expanding the use resources of the virtual reality device. Also, the voice recognition is performed in conjunction with the cloud management server, thereby enhancing the capacities of the voice recognition, solving the technical problem of inconvenient operation of the virtual reality device, and improving the user experience.

FIG. 5 is a structural block diagram of a virtual reality device according to the present disclosure. Referring to FIG. 5, the virtual reality device 1 includes: a controller 11, a wireless network circuit 12, a speech recognition circuit 13 and a microphone 14. The controller 12 is provided with the above apparatus 10 for controlling the virtual reality device. The wireless network circuit 12 and the speech recognition circuit 13 are connected to the controller 11. The microphone 14 is connected to the speech recognition circuit 13. The wireless network circuit 12 is connected to the Internet. The speech recognition circuit 13 is configured to convert a voice signal of the user into an operation instruction. The microphone 14 is configured to collect the voice signal inputted from the user. Optionally, the wireless network circuit may be one or more of a wireless network card, a wireless connector, and Bluetooth. Depending on the application field of the virtual reality device, the virtual reality device would also include other functional circuits, which are not listed here.

In the virtual reality device according to the present disclosure, the local speech recognition library only stores simple and direct operation instructions, thereby saving the storage of the virtual reality device. Also, the voice recognition is performed in conjunction with the cloud management server, thereby enhancing the capacities of the voice recognition, solving the technical problem of inconvenient operation of the virtual reality device, and improving the user experience.

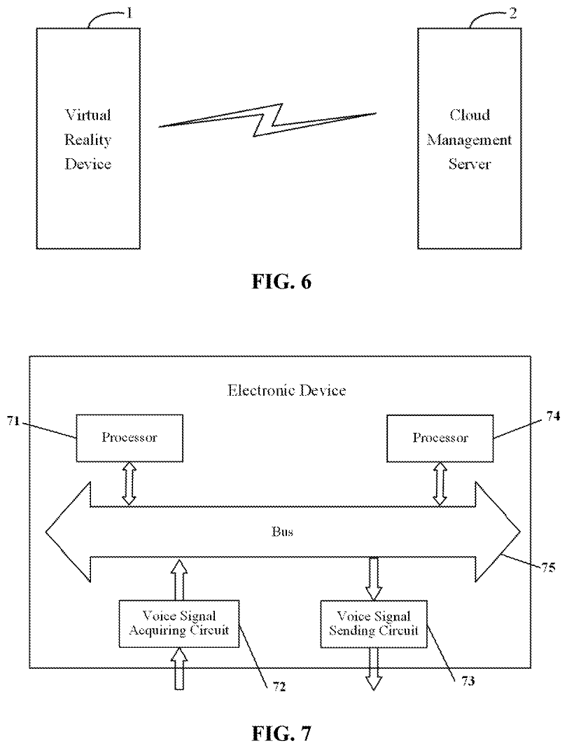

FIG. 6 is a structural block diagram of a virtual reality system according to the present disclosure. Referring to FIG. 6, the virtual reality system includes the above virtual reality device 1 and the cloud management server 2.

In the virtual reality device in the virtual reality system according to the present disclosure, the local speech recognition library only stores simple and direct operation instructions, thereby saving the storage of the virtual reality device. Also, the voice recognition is performed in conjunction with the cloud management server, thereby enhancing the capacities of the voice recognition, solving the technical problem of inconvenient operation of the virtual reality device, and improving the user experience.

An embodiment also provides a non-transitory computer readable storage medium for storing computer executable instructions which executes the method for controlling the virtual reality device according to any of the above embodiments.

FIG. 7 is a structural block diagram of an electronic device according to an embodiment of the present disclosure. The electronic device provided by the embodiment of the present disclosure may include a processor 71, a voice signal acquiring circuit 72, a voice signal sending circuit 73 and a memory 74, and may further include a bus 75. The processor 71, the voice signal acquiring circuit 72, the voice signal sending circuit 73, and the memory 74 can be in communication with each other via the bus 75. The voice signal acquiring circuit 72 is configured to acquire a voice signal of the user. The voice signal sending circuit 73 is configured to send the voice signal to the cloud management server for speech recognition if a local voice recognition library cannot recognize the voice signal. The processor 71 can call logic instructions in the memory 74 to execute the method for controlling the virtual reality device according to above embodiment.

In addition, the logic instructions in the memory 74 described above may be implemented in the form of software functional units, and may be stored in a computer-readable storage medium when being sold or used as a separate product. Based on this understanding, the technical solution of the present disclosure may be embodied in the form of a software product stored in a storage medium, which includes a plurality of instructions for causing a computer device (such as a personal computer, a server or a network device, etc.) to perform all or part of the steps of the method described in the above embodiments. The foregoing storage medium may be a non-transitory storage medium which includes a medium for storing program code, such as a USB flash drive, a mobile hard disk, a read-only memory (ROM), a random access memory (RAM), a magnetic disk or an optical disk, or may be a transitory storage medium.

The above content is only an alternative embodiment of the present disclosure.

### INDUSTRIAL APPLICABILITY

In the method for controlling the virtual reality device according to the present disclosure, the voice signal of the user is recognized by the local voice recognition library. When the local voice recognition library cannot recognize the voice signal, the voice signal will be sent to the cloud management server for performing the recognition. Then, the recognized operation instruction is sent to the virtual reality device. The virtual reality device executes the operation instruction, and acquires the resource matching the operation instruction from the Internet. The local speech recognition library only stores simple and direct operation instructions, thereby saving the storage of the virtual reality device. Also, the voice recognition is performed in conjunction with the cloud management server, thereby enhancing the capacities of the voice recognition, solving the technical problem of inconvenient operation of the virtual reality device, and improving the user experience.

1. A method for controlling a virtual reality device, comprising:
acquiring a voice signal;
performing local speech recognition on the voice signal;
sending the voice signal to a cloud management server for performing speech recognition, if the voice signal is not recognized by a local speech recognition library; and
receiving an operation instruction sent by the cloud management server which is obtained upon the recognition of the voice signal, executing the operation instruction and acquiring from the Internet the resource matching the operation instruction.

2. The method according to claim 1, wherein the speech signal recognizable by the local speech recognition library comprises at least one of: opening a video, playing a next video, playing a previous video, fast forward, fast backward, increasing a volume, decreasing a volume, pausing, continuing to play, and shutdown.

3. The method according to claim 1, wherein, after receiving the operation instruction sent by the cloud management server which is obtained upon the recognition of the voice signal, executing the operation instruction and acquiring from the Internet the resource matching the operation instruction, the method further comprises:
presenting the resource in at least one manner of speech, image, vibration, smell, and graphic-text displaying.

4. The method according to claim 1, wherein the receiving the operation instruction sent by the cloud management server which is obtained upon the recognition of the voice signal, executing the operation instruction and acquiring from the Internet the resource matching the operation instruction comprises:
receiving the operation instruction sent by the cloud management server which is obtained upon the recognition of the voice signal, with the operation instruction being a clothing brand, and acquiring a virtual store of the clothing brand from the Internet.

5. The method according to claim 1, wherein a speech recognition capability of the cloud management server is adaptively learned via speech recognition resources in a cloud.

6. An apparatus for controlling a virtual reality device, comprising:
a voice signal acquiring unit, configured to acquire a voice signal;
signal;
a voice signal sending unit, configured to send the voice signal to a cloud management server for performing speech recognition, if the voice signal is not recognized by a local speech recognition library; and
an operation instruction executing unit, configured to receive an operation instruction sent by the cloud management server which is obtained upon recognition of the voice signal, execute the operation instruction, and acquire from the Internet the resource matching the operation instruction.

7. The apparatus for controlling the virtual reality device according to claim 6, wherein the speech signal recognizable by the local speech recognition library comprises at least one of: opening a video, playing a next video, playing a previous video, fast forward, fast backward, increasing a volume, decreasing a volume, pausing, continuing to play, and shutdown.

8. The apparatus for controlling the virtual reality device according to claim 6, further comprising:
a result presenting unit, configured to present the resource in a manner of speech, image, vibration, smell or graphic-text displaying.

9. A virtual reality device, comprising:
a controller, a wireless network circuit, a speech recognition circuit and a microphone,
wherein the controller is provided with the apparatus for controlling the virtual reality device according to claim 6, the wireless network circuit and the speech recognition circuit are connected to the controller, the microphone is connected to the speech recognition circuit, the wireless network circuit is configured to connect to the Internet, the speech recognition circuit is configured to convert a voice signal into an operation instruction, and the microphone is configured to collect the voice signal.

10-11. (canceled)
